(19) United States
(12) Patent Application Publication
(10) Pub. No.: US 2016/0122197 A1
(43) Pub. Date: May 5, 2016

(54) MICROWAVE HEATING FOR GYPSUM MANUFACTURING PROCESSES

(71) Applicant: Georgia-Pacific Gypsum LLC, Atlanta, GA (US)

(72) Inventors: Mianxue Wu, Suwanee, GA (US); Jeffrey T. Fields, Suwanee, GA (US); Melisha Gardner, Carrollton, AL (US)

(73) Assignee: Georgia-Pacific Gypsum LLC, Atlanta, GA (US)

(21) Appl. No.: 14/930,682

(22) Filed: Nov. 3, 2015

Related U.S. Application Data
(60) Provisional application No. 62/074,159, filed on Nov. 3, 2014.

(51) Int. Cl. C01F 11/46

(52) U.S. Cl. CPC C01F 11/466

(57) ABSTRACT

Methods of making calcium sulfate whiskers are provided. In one aspect, a method includes autoclaving a slurry of calcium sulfate hemihydrate and water to form calcium sulfate hemihydrate whiskers in water and microwaving the whiskers to dewater them, wherein the microwaving is effective to prevent a majority of the whiskers from reverting to a dihydrate form. In one aspect, a method includes microwaving calcium sulfate hemihydrate whiskers to form anhydrite calcium sulfate whiskers, wherein the microwaving is effective to remove a substantial amount of chemically bound water from the whiskers.

### CROSS-REFERENCE TO RELATED APPLICATIONS

This application claims priority benefit of U.S. Provisional Application No. 62/074,159, filed on Nov. 3, 2014, which is incorporated by reference herein.

### TECHNICAL FIELD

The present disclosure relates generally to the field of calcium sulfate-based products and manufacturing, and more particularly to microwave heating for calcium sulfate whisker manufacturing processes.

### BACKGROUND

Various fillers are known for use as reinforcement, opacification and/or additives in paint, coatings, papermaking, and plastics. For example, fillers such as fiberglass, carbon black, calcium carbonate, silica, talc, kaolin, and aluminum hydroxide are currently used in these applications. However, fibrous fillers generally provide improved stiffness, strength, and thermal stability properties to composites, as compared to particulate and platelet shaped fillers.

Single crystal fibers, also known as “whiskers,” have been shown to provide improved properties in composites as compared to traditional fibers. For example, whiskers may provide improved surface quality and aesthetics for composites, because they are typically finer and smoother than fibers. Whiskers may also provide improved dimensional and thermal stability, increased strength and toughness, and higher fluidity (e.g., for improved mold casting). However, whiskers are difficult to economically manufacture, due to the slow growth rate of whiskers and the fragility of the materials.

Accordingly, there is a need for improved methods for manufacturing whiskers.

### SUMMARY

In one aspect, methods of making calcium sulfate whiskers are provided, including autoclaving a slurry of calcium sulfate hemihydrate and water to form calcium sulfate hemihydrate whiskers in water and microwaving the calcium sulfate hemihydrate whiskers to dewater the calcium sulfate hemihydrate whiskers, wherein the microwaving is effective to prevent the calcium sulfate hemihydrate whiskers from reverting to a dihydrate form.

In another aspect, methods of making calcium sulfate whiskers are provided, including microwaving calcium sulfate hemihydrate whiskers to form anhydrite calcium sulfate whiskers, wherein the microwaving is effective to remove a substantial amount of chemically bound water from the calcium sulfate hemihydrate whiskers.

### BRIEF DESCRIPTION OF THE DRAWINGS

Referring now to the drawings, which are meant to be exemplary and not limiting:

FIG. 1 is a graph showing the moisture removal effectiveness of various heating methods.

### DETAILED DESCRIPTION

Disclosed herein are methods of manufacturing calcium sulfate based whiskers and the whiskers made therefrom. These whiskers and methods meet one or more of the above-described needs by providing methods for preparing whiskers in which the integrity of the whiskers throughout the process is substantially maintained. That is, these methods may be used to more efficiently manufacture calcium sulfate whiskers having improved properties, such as high aspect ratio and integrity.

In certain embodiments, methods of making calcium sulfate whiskers are provided. As used herein, the term “whiskers” refers to single crystal fibers. Generally, the whiskers disclosed herein are made using calcium sulfate, which may also be referred to as gypsum or plaster. Calcium sulfate may exist as a hemihydrate (CaSO₄*½H₂O), a dihydrate (CaSO₄*2H₂O), or an anhydrite (CaSO₄). Generally, beta calcium sulfate hemihydrate, which is obtained from the calcination of dihydrate calcium sulfate under an elevated temperature at ambient pressure, may be used to prepare calcium sulfate whiskers. Alpha calcium sulfate hemihydrate may also be used and may provide additional advantages to whisker processing and properties. Alpha calcium sulfate hemihydrate, which has the same chemical composition as the beta form, has gone through a pressurized calcination process, which produces well-crystallized, prismatic particles. For example, the pressurized calcination process may be an autoclave process.

It should be understood that while the present disclosure generally relates to calcium sulfate hemihydrate raw starting materials, the use of other suitable starting materials is also envisioned and intended to fall within the scope of this disclosure. For example, other forms of calcium sulfate or other materials such as calcium carbonate that is reacted with sulfuric acid may be used.

Generally, the whisker-making process may include one or more of the following steps: (i) combining calcium sulfate hemihydrate and water to form a slurry; (ii) autoclaving a slurry of calcium sulfate hemihydrate and water to form calcium sulfate hemihydrate whiskers in water; (iii) dewatering the calcium sulfate hemihydrate whiskers; and (iv) heating the calcium sulfate hemihydrate whiskers to form anhydrite calcium sulfate whiskers, i.e., dead-burning the calcium sulfate hemihydrate whiskers. Such processes, steps, and features of the same are described in U.S. Provisional Patent Application No. 61/912,609 entitled “Gypsum Composite Modifiers,” filed Dec. 6, 2013, which is incorporated by reference herein in its entirety.

One important factor in obtaining high-quality and high-integrity whiskers is ensuring that water (chemically-bound water due to the conversion from a dihydrate to hemihydrate form and/or excess water due to the wet or semi-wet processes) is removed efficiently from the hemihydrate whiskers, so as to largely prevent the hemihydrate form from reverting, or rehydrating, into a dihydrate form. For example, it is believed that below a temperature of about 100° C., the whiskers begin to revert to a dihydrate form. It has been found that when any portion of a hemihydrate whisker is rehydrated into a dihydrate form (i.e., because the moisture content of the whisker is too high), the anhydrite whisker produced therefrom will display a weak spot at the location of the dihydrate reversion. That is, it has been determined that quickly dewatering the autoclaved material it is critical to producing optimal quality whiskers. Because the whiskers leaving the autoclave are at their highest quality throughout the process, effectively dewatering these hemihydrate whiskers while causing minimal damage and/or reversion to a dihydrate form is crucial to the manufacture of high-integrity whiskers.

Moreover, it is desirable to reduce the moisture content of the hemihydrate whiskers to below about 6%, by weight, if further conversion to the anhydrite form is desired. It has been determined that a whisker moisture content of about 6.2%, by weight, or lower indicates that the majority of the excess water has been removed from the whiskers. As used herein, the term “excess water” refers to physically free water present in the whiskers, as opposed to chemically bound water.

It has been discovered that microwave radiation is especially effective at dewatering calcium sulfate whiskers quickly, to produce high-integrity whiskers. In certain embodiments, microwaving is utilized to perform at least a portion of the step in which the hemihydrate whiskers are dewatered. In other embodiments, microwaving is utilized to perform the final heating, or dead-burning, step in which the anhydrite whiskers are formed. In some embodiments, microwaving, either in a single step or multiple steps, is utilized to perform both some portion of the dewatering of the hemihydrate whiskers as well as the final dead-burning to produce the anhydrite whiskers. Details of these embodiments are discussed below.

Manufacture of Hemihydrate Whiskers Using Microwave

In certain embodiments, methods of making calcium sulfate whiskers include: (i) autoclaving a slurry of calcium sulfate hemihydrate and water to form calcium sulfate hemihydrate whiskers in water, and (ii) microwaving the calcium sulfate hemihydrate whiskers to dewater the calcium sulfate hemihydrate whiskers. In some embodiments, the microwaving is effective to prevent a majority of the calcium sulfate hemihydrate whiskers from reverting to a dihydrate form.

As used herein, the phrase “a majority of the calcium sulfate hemihydrate whiskers” refers to a percentage of the number of whiskers in a given sample. That is, more than 50% of the whiskers present in a sample may be prevented from reverting to a dihydrate form. In certain embodiments, at least 60% of the whiskers present in the sample may be prevented from reverting to a dihydrate form. For example, from about 60% to about 99.9% of the whiskers present in the sample may be prevented from reverting to a dihydrate form.

In certain embodiments, the microwaving is effective to remove a substantial amount of physically free water from the calcium sulfate hemihydrate whiskers. For example, the microwaving may be effective to reduce a moisture content of the calcium sulfate hemihydrate whiskers to 20% or less, to 10% or less, or to 6% or less, by weight. As used herein, the term “moisture content” refers to the percentage, by weight, of moisture present in the calcium hemihydrate whiskers. For example, the moisture content of the hemihydrate whiskers after the microwaving may be from 0.1% to about 30%, by weight. For example, the moisture content of the whiskers after microwaving may be from about 5% to about 10%, by weight.

In certain embodiments, the microwaving is effective to reduce a moisture content of the calcium sulfate hemihydrate whiskers by at least 40%, by weight. In certain embodiments, the microwaving is effective to reduce a moisture content of the calcium sulfate hemihydrate whiskers by at least 50%, by weight. In certain embodiments, the microwaving is effective to reduce a moisture content of the calcium sulfate hemihydrate whiskers by at least 60%, by weight.

In certain embodiments, the microwaving is performed at a power level of at least 1000 watts. In certain embodiments, the microwaving is performed at a power level of at least 1200 watts. For example, the microwaving may be performed at a power level of from about 1000 to about 1500 watts. In some embodiment, the microwaving maintains the calcium sulfate hemihydrate whiskers at a temperature of 100° C. or above, such that the calcium sulfate hemihydrate whiskers cannot revert into a dihydrate form.

In certain embodiments, the methods also include combining calcium sulfate hemihydrate and water to form the slurry. In one embodiment, the step of combining the calcium sulfate hemihydrate and water includes combining the calcium sulfate hemihydrate with the water such that the calcium sulfate is present in the slurry in an amount from about 1 to about 40 percent by weight of the slurry. For example, the calcium sulfate hemihydrate may be combined with the water such that the calcium sulfate is present in the slurry in an amount from about 2 to about 20 percent by weight of the slurry. In one embodiment, the calcium sulfate hemihydrate may be combined with the water such that the calcium sulfate is present in the slurry in an amount from about 5 to about 25 percent by weight of the slurry. In one embodiment, the slurry contains calcium sulfate in an amount of about 15 percent by weight of the slurry. Without being bound by a particular theory, it is believed that the combination of calcium sulfate hemihydrate and water results in dihydrate crystals in the slurry. For example, the calcium sulfate hemihydrate may be alpha calcium sulfate hemihydrate, beta calcium sulfate hemihydrate, or a combination thereof.

In certain embodiments, the calcium sulfate hemihydrate has a median particle size from about 1 μm to about 100 μm, such as from about 1 μm to about 20 μm. For example, the calcium sulfate hemihydrate may have a median particle size from about 1 μm to about 10 μm, or from about 2 to about 5 μm.

In certain embodiments, the calcium sulfate hemihydrate has a fine or finer size. As used herein, the terms “fine” and “finer” refer to particles having a median particle size smaller than that of commercially obtained particles. In certain embodiments, fine calcium sulfate hemihydrate particles also have a narrow particle size distribution as compared to that of commercially obtained particles. For example, fine calcium sulfate hemihydrate particles may have a narrow particle size distribution in which the 90^{th} percentile of particles, by size, has a size that is no more than 150% more than the 50^{th} percentile of particles. For example, fine calcium sulfate hemihydrate particles may have a narrow particle size distribution in which the 100^{th} percentile of particles, by size, has a size that is no more than 500% more than the 50^{th} percentile of particles. For example, fine calcium sulfate hemihydrate particles may have a narrow particle size distribution in which the 100^{th} percentile of particles, by size, has a size that is no more than 2000% more than the 10^{th} percentile of particles. That is, the fine particles may have a more uniform size distribution, in addition to a smaller median particle size, as compared to commercially obtained particles.

In certain embodiments, methods of making anhydrite calcium sulfate whiskers further include sizing the calcium sulfate hemihydrate to form fine calcium sulfate hemihydrate having a median particle size from about 1 μm to about 10 μm, prior to combining the calcium sulfate hemihydrate and water to form a slurry. For example, the fine calcium sulfate hemihydrate may be sized have a median particle size from about 1 to about 5 μm. For example, the calcium sulfate hemihydrate may be sized by jet mill, pulverization, comminution, separation, micronization, grinding, or other suitable sizing or fining processes known to those of ordinary skill in the art.

As used herein, the term “autoclaving” refers to exposing the slurry of calcium sulfate hemihydrate and water to saturated steam in a pressurized environment. In one embodiment, autoclaving the slurry comprises subjecting the slurry to saturated steam at a pressure of from about 5 psig to about 55 psig and a temperature of from about 100° C. to about 150° C. for a duration of from about 30 minutes to about 8 hours. In one embodiment, the step of autoclaving the slurry includes subjecting the slurry to saturated steam at a pressure from about 0 psig to about 50 psig and a temperature from about 100° C. to about 150° C. for a duration from about 30 minutes to about 8 hours. For example, the step of autoclaving the slurry may include subjecting the slurry to saturated steam at a pressure from about 1 psig to about 30 psig and a temperature from about 101° C. to about 134° C. for a duration from about 30 minutes to about 8 hours. For example, such autoclave parameters may be applied in a small-scale production setting, such as in the lab. For example, the step of autoclaving the slurry may include subjecting the slurry to saturated steam at a pressure from about 30 psig to about 52 psig and a temperature from about 134° C. to about 150° C. for a duration from about 30 minutes to about 8 hours. For example, such autoclave parameters may be applied in an industrial-scale production setting. Without being bound by a particular theory, it is believed that the calcium sulfate dihydrate crystals dissolve during the autoclave process and reform as hemihydrate whiskers at the high pressure.

The calcium sulfate hemihydrate whiskers may then be dewatered, i.e., the whiskers may be separated from water. In certain embodiments, at least a portion of the dewatering is performed via microwaving the calcium sulfate hemihydrate whiskers, as described above. In certain embodiments, the step of dewatering the calcium sulfate hemihydrate whiskers also includes filtering, vacuuming, centrifuging, or a combination thereof. For example, a screen filter may be used to dewater the whiskers. In one embodiment, the step of dewatering the calcium sulfate hemihydrate whiskers includes filtering the calcium sulfate hemihydrate whiskers. For example, filtering, vacuuming, or centrifuging may be performed prior to the microwaving. In one embodiment, the step of dewatering includes filtering the calcium sulfate hemihydrate whiskers for a duration of from about 1 to about 10 minutes, prior to the microwaving step.

It has been found that microwaving the hemihydrate whiskers to accomplish at least a portion of the whisker dewatering advantageously produces whiskers having improved properties, such as high aspect ratio and integrity. In particular, without intending to be bound by a particular theory, it has been found that dewatering via microwaving ensures that water (chemically-bound water due to the conversion from a dihydrate to hemihydrate form and/or excess water due to the wet or semi-wet processes) is removed efficiently from the hemihydrate whiskers, so as to largely prevent the hemihydrate form from reverting, or rehydrating, into a dihydrate form. As such, the hemihydrate whiskers display significantly fewer weak spots than whiskers dewatered by methods other than microwave. This lack of weak spots results in whiskers having high-integrity and increased aspect ratio.

In certain embodiments, the calcium sulfate hemihydrate whiskers have a mean aspect ratio from about 30 to about 140. In some embodiments, the calcium sulfate hemihydrate whiskers have a mean aspect ratio from about 40 to about 115. For example, from about 90 to about 99 percent of the calcium sulfate hemihydrate whiskers may have an aspect ratio of at least 50. For example, from about 90 to about 95 percent of the calcium sulfate hemihydrate whiskers may have an aspect ratio of at least 50.

In certain embodiments, the calcium sulfate hemihydrate whiskers have a mean diameter from about 0.3 μm to about 1.5 μm. In certain embodiments, the calcium sulfate hemihydrate whiskers have a mean diameter from about 0.4 μm to about 1.4 μm. In certain embodiments, the calcium sulfate hemihydrate whiskers have a mean length from about 20 μm to about 100 μm. In certain embodiments, the calcium sulfate hemihydrate whiskers have a mean length from about 40 μm to about 80 μm.

The calcium sulfate hemihydrate whiskers may then be heated, or “dead burned,” to achieve a stable, insoluble anhydrite form. In certain embodiments, the step of heating the calcium sulfate hemihydrate whiskers to form anhydrite calcium sulfate whiskers includes heating the calcium sulfate hemihydrate whiskers at a temperature from about 500° C. to about 900° C. for a duration from about 20 to about 24 hours. In one embodiment, the step of heating the calcium sulfate hemihydrate whiskers to form anhydrite calcium sulfate whiskers includes heating the calcium sulfate hemihydrate whiskers at a temperature from about 600° C. to about 700° C. for a duration from about 1 to about 2 hours.

In certain embodiments, as discussed in more detail below, heating the calcium sulfate hemihydrate whiskers to form anhydrite calcium sulfate whiskers includes microwaving the calcium sulfate hemihydrate whiskers, and the microwaving is effective to remove a substantial amount of chemically bound water from the calcium sulfate hemihydrate whiskers.

In certain embodiments, both a portion of the dewatering as well as the dead burning are performed via microwave. For example, a single microwave step may be performed to achieve dewatering and then dead burning. In certain embodiments, a microwave step in which two power levels are used (i.e., a lower power level for the dewatering and a higher power level for the dead burning) is performed.

In certain embodiments, the dewatering microwave step, the dead burning microwave step, or a combination of both steps is performed for a period of 20 minutes or more. In one embodiment, the dewatering microwave step, the dead burning microwave step, or a combination of both steps is performed for a period of from about 20 minutes to about 24 hours. In one embodiment, the dewatering microwave step, the dead burning microwave step, or a combination of both steps is performed for a period of from about 1 hour to about 5 hours.

In certain embodiments, the microwaving is effective to produce anhydrite calcium sulfate whiskers having a Mohs hardness from about 3 to about 3.5. In certain embodiments, the microwaving is effective to produce anhydrite calcium sulfate whiskers that are thermally stable up to at least 1450° C.

Manufacture of Anhydrite Whiskers Using Microwave

In certain embodiments, methods of making calcium sulfate whiskers include microwaving calcium sulfate hemihydrate whiskers to form anhydrite calcium sulfate whiskers, wherein the microwaving is effective to remove a substantial amount of chemically bound water from the calcium sulfate hemihydrate whiskers. That is, microwaving may be used to dead burn the hemihydrate whiskers to produce anhydrite whiskers.

In certain embodiments, the microwaving is effective to heat the calcium sulfate hemihydrate whiskers to a temperature from about 500° C. to about 900° C. for a period of from about 20 minutes to about 24 hours. In certain embodiments, the microwaving is performed at a power level of at least 1000 watts. In certain embodiments, the microwaving is performed at a power level of at least 1200 watts. For example, the microwaving may be performed at a power level of from about 1000 to about 1500 watts.

In certain embodiments, the microwaving is performed for a period of 20 minutes or more. For example, the microwaving may be performed for a period from about 20 minutes to about 24 hours. In one embodiment, the microwaving may be performed for a period from about 1 hour to about 5 hours.

In certain embodiments, the microwaving is effective to produce anhydrite calcium sulfate whiskers having a Mohs hardness from about 3 to about 3.5. In certain embodiments, the microwaving is effective to produce anhydrite calcium sulfate whiskers that are thermally stable up to at least 1450° C.

In certain embodiments, the anhydrite calcium sulfate whiskers have a mean aspect ratio from about 30 to about 140. In certain embodiments, the anhydrite calcium sulfate whiskers have a mean aspect ratio from about 40 to about 115. In certain embodiments, from about 90 to about 99 percent of the anhydrite calcium sulfate whiskers have an aspect ratio of at least 50. In certain embodiments, from about 90 to about 95 percent of the anhydrite calcium sulfate whiskers have an aspect ratio of at least 50.

In certain embodiments, the anhydrite calcium sulfate whiskers have a mean diameter from about 0.3 μm to about 1.5 μm. In certain embodiments, the anhydrite calcium sulfate whiskers have a mean diameter from about 0.4 μm to about 1.4 μm. In certain embodiments, the anhydrite calcium sulfate whiskers have a mean length from about 20 μm to about 100 μm. In certain embodiments, the anhydrite calcium sulfate whiskers have a mean length from about 40 μm to about 80 μm.

Without being bound by a particular theory, it is believed that microwaving the dewatered whiskers results in removal of a significant portion of the chemically bound water in the whiskers, further increasing the thermal and moisture stability of the product, i.e., phase II anhydrite whiskers. In particular, it is believed that the microwave is able to reach the desired temperatures of 600° C. to 1000° C., which are desirable for dead burning, in a short period of time.

Whiskers and Compositions Thereof

Compositions of anhydrite calcium sulfate whiskers are also provided. For example, these whiskers may be produced by the methods disclosed herein. For example, these whiskers may be the product formed by the dewatering and/or dead burning steps described above.

In certain embodiments, compositions include anhydrite calcium sulfate whiskers having a mean aspect ratio of at least 30. As used herein, the term “mean” in relation to dimensions of the whiskers, refers to the average dimension of a sample of the whiskers.

In one embodiment, the anhydrite calcium sulfate whiskers have a mean aspect ratio of at least 30. As used herein, the term “aspect ratio” refers to the ratio of the length of a calcium sulfate whisker to its diameter, or the ratio of the average whisker length to the average whisker diameter for a sample of whiskers. In certain embodiments, the anhydrite calcium sulfate whiskers have a mean aspect ratio from about 30 to about 140. For example, the anhydrite calcium sulfate whiskers may have a mean aspect ratio from about 40 to about 115.

In certain embodiments, from about 90 to about 99 percent of the anhydrite calcium sulfate whiskers have an aspect ratio of at least 50. That is, the anhydrite calcium sulfate whiskers formed by the whisker manufacturing process may display a particle size distribution wherein substantially all of the whiskers have an aspect ratio of at least 50. In one embodiment, from about 90 to about 95 percent of the anhydrite calcium sulfate whiskers have an aspect ratio of at least 50. As used herein, the phrases “from about 90 to about 99 percent of the anhydrite calcium sulfate whiskers,” “from about 90 to about 95 percent of the anhydrite calcium sulfate whiskers,” and similar phrases refer to a percentage of the number of whiskers in a given sample. Percentage measurements given by weight are indicated as such herein.

In certain embodiments, the anhydrite calcium sulfate whiskers have a mean diameter from about 0.3 μm to about 1.5 μm. In one embodiment, the anhydrite calcium sulfate whiskers have a mean diameter from about 0.4 μm to about 1.4 μm. In certain embodiments, the anhydrite calcium sulfate whiskers have a mean length from about 20 μm to about 100 μm. In one embodiment, the anhydrite calcium sulfate whiskers have a mean length from about 40 μm to about 80 μm.

In one embodiment, the anhydrite calcium sulfate whiskers have a mean length from about 60 μm to about 75 μm, a mean diameter from about 1.0 μm to about 1.5 μm, and a mean aspect ratio from about 40 to about 75.

The anhydrite calcium sulfate whiskers may display one or more strength, hardness, or stability properties, as described herein. In certain embodiments, the anhydrite calcium sulfate whiskers have a Mohs hardness from about 3 to about 3.5. In certain embodiments, the anhydrite calcium sulfate whiskers are thermally stable up to at least 1450° C. As used herein, the term “thermally stable” refers to the whiskers being resistant to decomposition at a given temperature.

In certain embodiments, particularly those in which fine calcium sulfate hemihydrate is used as the starting material, the anhydrite calcium sulfate whiskers have a mean aspect ratio of at least 50. That is, the fine particle-derived whiskers may have an increased aspect ratio relative to other particle-derived whiskers. In one embodiment, the whiskers have a mean aspect ratio mean aspect ratio from about 55 to about 140. In certain embodiments, from about 90 to about 99 percent of the anhydrite calcium sulfate whiskers have an aspect ratio of at least 60. In one embodiment, from about 90 to about 95 percent of the anhydrite calcium sulfate whiskers have an aspect ratio of at least 60.

In certain embodiments, the anhydrite calcium sulfate whiskers have a mean diameter from about 0.4 μm to about 1.0 μm. In one embodiment, the anhydrite calcium sulfate whiskers have a mean diameter from about 0.4 μm to about 0.8 μm. In certain embodiments, the anhydrite calcium sulfate whiskers have a mean length from about 40 μm to about 80 μm. In one embodiment, the anhydrite calcium sulfate whiskers have a mean length from about 45 μm to about 55 μm.

In one embodiment, fine particle-derived anhydrite calcium sulfate whiskers have a mean length from about 45 μm to about 55 μm, a mean diameter from about 0.4 μm to about 0.8 μm, and a mean aspect ratio from about 55 to about 140.

### Examples

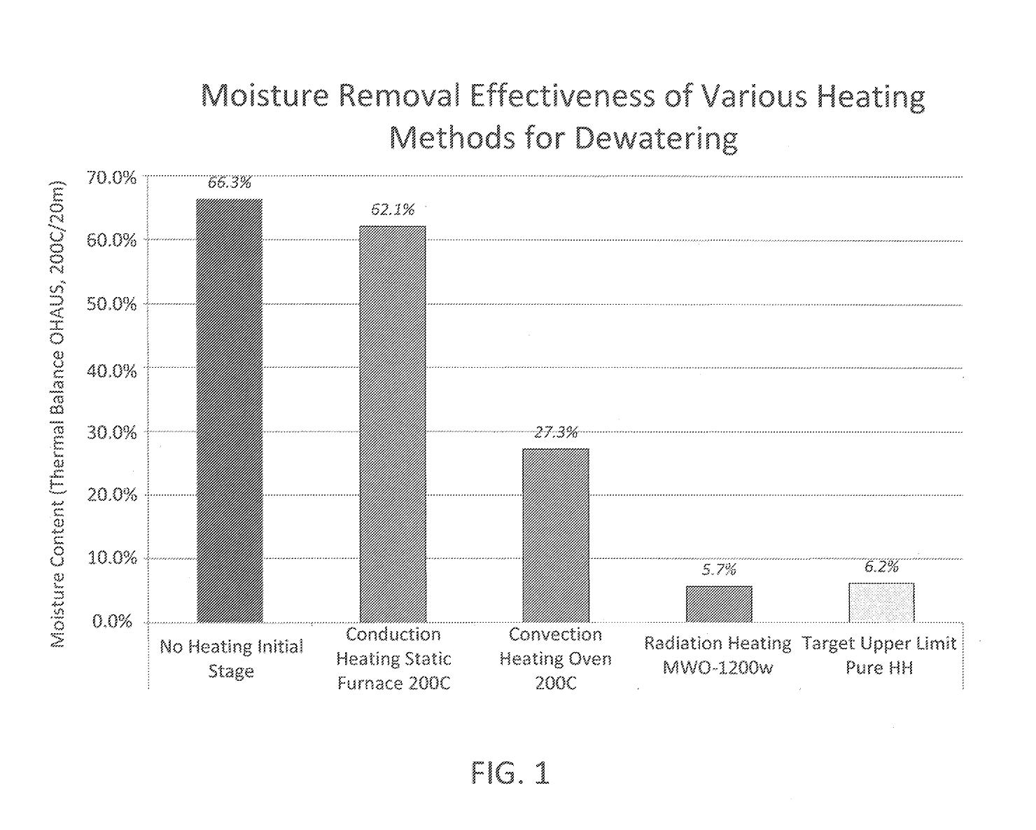

Embodiments of the calcium sulfate whiskers were manufactured and tested. The results are shown below and at FIG. 1.

Calcium sulfate whiskers were made using alpha hemihydrate particles, according to the following method. Calcium sulfate hemihydrate was combined with water to form a slurry containing 5 weight percent calcium sulfate. The slurry was autoclaved at a pressure of 10 psig and a temperature of 115° C. for 3 hours to form whiskers. 2500 gram samples of the reacted slurry containing grown whiskers were screen filtered for 5 minutes to produce semi-dry 375 gram whisker cake samples. The semi-dry samples were then further dewatered by heating for 30 minutes by various heating methods. In particular, one sample was heated via conduction heating in a static furnace at 200° C., one sample was heated via circulated forced air (convection) in an oven at 200° C., and one sample was heated in a microwave oven.

The moisture content of the starting material and each sample after heating was measured using an OHAUS moisture analyzer at 200° C./20 minutes. The results are shown in FIG. 1.

As shown in FIG. 1, the starting semi-dry material displayed a moisture content of 66.3%, by weight. The moisture content of the sample heated in the static furnace was reduced to 62.1%, by weight. The moisture content of the sample heated in the convection oven was reduced to 27.3%, by weight. The moisture content of the sample heated in the microwave oven was reduced to 5.7%, by weight. It has been theorized that for conversion from the hemihydrate form to the anhydrite form, the whiskers should display a moisture content of about 6.2% or lower, by weight, indicating that all of the physically free, or excess, water has been removed from the whiskers. These tests confirm that microwaving the hemihydrate whiskers to perform at least a portion of the dewatering is especially effective at dewatering calcium sulfate whiskers quickly, and thereby produce high-integrity whiskers.

Further tests were performed to compare the various dewatering heating methods. In particular, Table 1 shows the moisture content and observations of various hemihydrate whisker samples (prepared according to the method described above) after 5 minutes or 30 minutes of heating by the noted methods. The samples included a 200 g slurry (about 10 g solid; 190 g water) without being pre-vacuumed (i.e., filtered). One of the samples that was microwaved was also vacuum filtered to achieve a 70 g cake after pre-vacuum (about 20 g solid; 50 g water). Some of the samples were dead burned.

In certain embodiments a “tall bowl,” with dimensions of a 4 inch diameter and a 6 inch depth was used to contain the slurry. In certain embodiments, an “open bowl,” with dimensions of an 8 inch diameter and a 6 inch depth was used to contain the slurry. In certain embodiments, a “rice bowl,” with dimensions of an 8 inch diameter and a 4 inch depth was used to contain the slurry. In certain embodiments, a “bacon tray,” with dimensions of a 10 inch by 8 inch base and a 1 inch depth was used to contain the slurry.

As used in Tables 1 and 2, the abbreviation “T” refers to the measured temperature, “MC” refers to the measured moisture content of the whiskers, by weight, “DB” refers to the dead burn step, and “L/D” refers to the ratio of length to diameter, also known as the aspect ratio, and “DH” refers to the dihydrate form.

TABLE 1
Moisture Content and Observations of Various Dewatering
Heating Methods for 5 and 30 minute durations

| | Static | Convention | Microwave | Microwave |
|---|---|---|---|---|
| | Furnace | Oven | Oven | Oven |
| | (Conduction) | (Convection) | 1200 watts | 1200 watts |
| | 200° C. | 200° C. | (Radiation) | (Radiation) |
| | Sample w/o | Sample w/o | Sample w/o | Sample w/ |
| | pre-vacuum | pre-vacuum | pre-vacuum | pre-vacuum |
| 5 min | | | T = 99.8° C. | T = 78° C. |
| heating | | | (tall bowl) | (tall bowl) |
| | | | MC = 83.8% | MC = 37.4% |
| | | | Pre-DB: some | Pre-DB: Some |
| | | | DH, good L/D | DH, good L/D |
| | | | Post-DB: some | Post-DB: some |
| | | | rehydration, | rehydration, |
| | | | lower L/D | lower L/D |
| 30 min | MC = 92.4% | MC = 89.8% | T = 90° C. | T = 140° C. |
| heating | (tall bowl) | (tall bowl) | (tall bowl) | (tall bowl) |
| | Pre-DB: | MC = 73.5% | MC = 5.4% | MC = 5.3% |
| | almost | (open bowl) | Pre-DB: no DH, | Pre-DB: few |
| | rehydration | Pre-DB: | good L/D | HD, |
| | | almost | Post-DB: no | good L/D |
| | | converted, | rehydration, | Post-DB: some |
| | | low L/D | slightly | rehydration, |
| | | | lower L/D | good L/D |
| | | | T = 153° C. | |
| | | | (open bowl) | |
| | | | MC = 1.3% | |
| | | | Pre-DB: bent | |
| | | | whiskers, no | |
| | | | DH | |
| | | | Post-DB: no | |
| | | | rehydration, | |
| | | | good L/D | |

Table 1, like FIG. 1, generally shows that microwaving is significantly more effective at removing water from the whiskers than conduction or convection methods. In particular, for the tall bowl non-vacuumed samples that were heated for 30 minutes, conduction resulted in a moisture content of 92.4%, by weight, almost rehydration, convection resulted in a moisture content of 89.8%, by weight, and microwaving resulted in a moisture content of 5.4%, by weight. Additionally, the similar sample that was microwaved for only 5 minute had a moisture content of 83.8%, by weight, lower than the moisture content of the samples heated by conduction and convection for 30 minutes. This shows that microwaving is significantly more efficient at lowering the moisture content of the whiskers than the conventional methods.

The results in Table 1 also show that vacuum filtering the samples prior to heating enhances the dewatering effect of the microwave. For example, the sample that was vacuumed prior to microwaving for 5 minutes, had a moisture content of 37.4%, by weight, after microwaving, compared to the moisture content of 83.8%, by weight of the non-vacuumed sample. For the samples that were microwaved for 30 minutes, the vacuum filtration appeared to have less of an impact. In particular, the non-vacuumed sample had a moisture content of 5.4%, by weight, while the pre-vacuumed sample had a moisture content of 5.3%, by weight. Also, it was found that the open bowl container provided for additional dewatering as compared to the tall container.

Table 2 shows the moisture content and quality of samples of various sizes and in various containers, which were subjected to microwave dewatering. These samples were not pre-vacuumed. The small sample size was about a 200 g slurry (about 10 g solid; 190 g water), while the large sample size was about 2500 g slurry (about 120 g solid; 2400 g water).

TABLE 2
Moisture Content and Quality of Samples of Various Sizes and in
Various Containers, Which Were Subjected to Microwave Dewatering

| | | | 2500 g slurry | 2500 g slurry |
|---|---|---|---|---|
| | | | in “Rice | in “Bacon |
| | 200 g slurry | 200 g slurry | Bowl” | Tray” |
| | in tall bowl | in open bowl | Perforated | Perforated |
| | No lid | No lid | lid | lid |
| Sample | T = 90° C. | T = 153° C. | T = 98.5° C. | T = 100.8° C. |
| Temperature | MC = 5.4% | MC = 1.3% | MC = 87.2% | MC = 68.8% |
| and Moisture | | | | |
| Content | | | | |
| Quality | Pre-DB: no | Pre-DB: bent | Pre-DB: long | Pre-DB: long |
| | DH, good | whiskers, no | whiskers but | whiskers but |
| | L/D | DH | with some | with few |
| | Post-DB: no | Post-DB: no | DH | DH |
| | rehydration, | rehydration, | starting | starting |
| | slightly | good L/D | Post-DB: | Post-DB: |
| | lower L/D | | shorter | shorter |
| | | | whiskers | whiskers |

Table 2 shows that that the larger samples in containers having lids were not dewatered by microwaving as efficiently as the smaller samples in containers without lids. Again, the open bowl container resulted in the most significant dewatering, to 1.3% moisture, by weight, for the small size sample. However, containers having lids were able to maintain more of the product throughout the microwaving process. As such, the sample size and container type must be selected for ideal moisture content and sample containment.

Without intending to be bound by a particular theory, in conventional drying methods, heat is transferred to the surface of the material and into the interior of the material by thermal conduction, convection, and sometimes radiation. Moisture is initially flashed off from the surface and the remaining water diffuses to the surface. This can a very slow process as the diffusion rate is limited, requiring high external temperatures, and therefore high energy consumption, to generate the temperature differences required. Accordingly, the process duration is often limited by the rate of the heat flow into the body of the material from the surface as determined by the specific heat, thermal conductivity, density, and viscosity of the material and the of container.

On the other hand, microwave is a form of energy designed to excite water molecules, resulting in very rapid drying without the need to overheat the atmosphere, as the energy is mainly absorbed by “water” in the cavity. Accordingly, microwave heating can cut energy and operation costs, increase process output, and minimize the carbon footprint of the process. Moreover, as demonstrated by the above examples, microwaving may be used to efficiently manufacture calcium sulfate whiskers having improved properties, such as high aspect ratio and integrity, by effectively dewatering and/or dead burning the hemihydrate whiskers while causing minimal damage and/or reversion to a dihydrate form. In particular, microwaving may be used to effectively remove chemically-bound and/or excess water from the hemihydrate whiskers, providing a fast, effective, and economical (e.g., by using about 1/10^{th} the energy to dewater the whiskers) way to achieve whiskers having optimal quality.

While the disclosure has been described with reference to a number of embodiments, it will be understood by those skilled in the art that the disclosure is not limited to such disclosed embodiments. Rather, the disclosed embodiments can be modified to incorporate any number of variations, alterations, substitutions, or equivalent arrangements not described herein, but which are commensurate with the spirit and scope of the disclosure.

What is claimed is:

1. A method of making calcium sulfate whiskers, comprising:
autoclaving a slurry of calcium sulfate hemihydrate and water to form calcium sulfate hemihydrate whiskers in water; and
microwaving the calcium sulfate hemihydrate whiskers to dewater the calcium sulfate hemihydrate whiskers,
wherein the microwaving is effective to prevent a majority of the calcium sulfate hemihydrate whiskers from reverting to a dihydrate form.

2. The method of claim 1, wherein the microwaving is effective to remove a substantial amount of physically free water from the calcium sulfate hemihydrate whiskers.

3. The method of claim 1, wherein the microwaving effective to reduce a moisture content of the calcium sulfate hemihydrate whiskers to 20% or less, by weight.

4. The method of claim 1, wherein the microwaving is effective to reduce a moisture content of the calcium sulfate hemihydrate whiskers by at least 40%, by weight.

5. The method of claim 1, wherein the microwaving is performed at a power level of at least 1000 watts.

6. The method of claim 1, wherein the microwaving maintains the calcium sulfate hemihydrate whiskers at a temperature of 100° C. or above, such that the calcium sulfate hemihydrate whiskers cannot revert into a dihydrate form.

7. The method of claim 1, wherein the calcium sulfate hemihydrate comprises alpha calcium sulfate hemihydrate or beta calcium sulfate hemihydrate.

8. The method of claim 1, wherein the slurry contains calcium sulfate in an amount from about 1 to about 40 percent by weight of the slurry.

9. The method of claim 1, wherein autoclaving the slurry comprises subjecting the slurry to saturated steam at a pressure of from about 5 psig to about 55 psig and a temperature of from about 100° C. to about 150° C. for a duration of from about 30 minutes to about 8 hours.

10. The method of claim 1, further comprising heating the calcium sulfate hemihydrate whiskers to form anhydrite calcium sulfate whiskers.

11. The method of claim 10, wherein heating the calcium sulfate hemihydrate whiskers to form anhydrite calcium sulfate whiskers comprises heating the calcium sulfate hemihydrate whiskers at a temperature from about 500° C. to about 900° C. for a duration from about 1 to about 24 hours.

12. The method of claim 10, wherein:
heating the calcium sulfate hemihydrate whiskers to form anhydrite calcium sulfate whiskers comprises microwaving the calcium sulfate hemihydrate whiskers, and
the microwaving is effective to remove a substantial amount of chemically bound water from the calcium sulfate hemihydrate whiskers.

13. The method of claim 12, wherein the microwaving is effective to produce anhydrite calcium sulfate whiskers having a Mohs hardness from about 3 to about 3.5.

14. The method of claim 12, wherein the microwaving is effective to produce anhydrite calcium sulfate whiskers that are thermally stable up to at least 1450° C.

15. A method of making calcium sulfate whiskers, comprising:
microwaving calcium sulfate hemihydrate whiskers to form anhydrite calcium sulfate whiskers,
wherein the microwaving is effective to remove a substantial amount of chemically bound water from the calcium sulfate hemihydrate whiskers.

16. The method of claim 15, wherein the microwaving is effective to produce anhydrite calcium sulfate whiskers having a Mohs hardness from about 3 to about 3.5.

17. The method of claim 15, wherein the microwaving is effective to produce anhydrite calcium sulfate whiskers that are thermally stable up to at least 1450° C.

18. The method of claim 15, wherein the microwaving is effective to heat the calcium sulfate hemihydrate whiskers to a temperature from about 500° C. to about 900° C. for a period of from about 1 to about 24 hours.

19. The method of claim 15, wherein the anhydrite calcium sulfate whiskers have a mean aspect ratio from about 30 to about 140.

20. The method of claim 15, wherein from about 90 to about 99 percent of the anhydrite calcium sulfate whiskers have an aspect ratio of at least 50.
